(19) United States
(12) Patent Application Publication
(10) Pub. No.: US 2002/0158395 A1
(43) Pub. Date: Oct. 31, 2002

(54) Chemical mechanical polishing method and semiconductor device manufacturing method

(76) Inventors: Naohito Mizuno, Yokohama-shi (JP); Dai Fukushima, Sagamihara-shi (JP); Hiroyuki Yano, Yokohama-shi (JP); Yoshikuni Tateyama, Hiratsuka-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/107,311

(22) Filed: Mar. 28, 2002

(30) Foreign Application Priority Data
Mar. 30, 2001 (JP) 2001-098855

(51) Int. Cl. B23Q 3/08

(52) U.S. Cl. 269/32

(57) ABSTRACT

A chemical mechanical polishing method comprises preparing a workpiece to be treated and chemically and mechanically polishing the workpiece to be treated by pressing the workpiece to be treated against a rotating disk carrying a piece of abrasive cloth bonded to the surface thereof at a first position on the disk, while dropping abrasive solution on the abrasive cloth, and, in parallel with the polishing, dressing the abrasive cloth by pressing a dresser carrying diamond grains sticked thereto against the abrasive cloth at a second position on the disk.

### CROSS-REFERENCE TO RELATED APPLICATIONS

This application is based upon and claims the benefit of priority from the prior Japanese Patent Application No. 2001-098855, filed Mar. 30, 2001, the entire contents of which are incorporated herein by reference.

### BACKGROUND OF THE INVENTION

1. Field of the Invention

This invention relates to a semiconductor device manufacturing method. More particularly, the present invention relates to a CMP (chemical mechanical polishing) technique.

2. Description of the Related Art

Known CMP methods are normally used to planarize the surfaces of thin films such as insulating films and metal films formed on semiconductor wafers by means of CVD (chemical vapor deposition) or some other technique.

Thus, the CMP method is used to planarize the thin films formed on the surface of a semiconductor wafer by making an abrasive agent containing abrasive grains fit to the surface of abrasive cloth and polishing the semiconductor wafer on a rotating abrasive disk. CMP apparatus that play an important role in manufacturing semiconductor devices comprise a CMP section for polishing the films on the surface of a semiconductor wafer and a cleaning section for cleaning the polished semiconductor wafer.

More accurately, the CMP apparatus comprises a chamber, a CMP section arranged in the inside of the chamber and a cleaning section. A wafer loading/unloading section is also arranged in the chamber and the CMP section includes a dressing unit and a CMP unit.

With CMP, an abrasive agent referred to as slurry and containing abrasive grains is fitted to the surface of abrasive cloth and the cloth is used to polish a semiconductor wafer arranged on a rotating abrasive disk in order to planarize the surface of the thin films formed on the surface of a substrate to be treated. However, as the abrasive cloth is used continuously for CMP, the surface of the abrasive cloth becomes clogged by slurry to degrade its polishing performance. A surface treatment technique referred to as conditioning (dressing) is used to get rid of the clogging due to slurry.

Various materials may be used for abrasive cloth that is by turn used with the CMP technique. Of these, polyurethane foam pads are popular. A polyurethane foam pad has densely arranged micro-pores on the surface, and the micro-pores hold slurry during the polishing operation. When a polyurethane foam pad is used for a polishing operation, an initial treatment referred to as conditioning that is an operation of making the surface slightly coarse before the use of the pad is required. Without such a treatment for making the surface coarse, the pad cannot provide a stabilized polishing rate and a uniform polishing effect.

Generally, as the CMP process progress, solid substances including ground-off particles and abrasive particles deposit on the abrasive cloth and the polishing rate is reduced as the deposit increases. Then, in such a case, the abrasive cloth needs to be subjected to a conditioning operation. However, the surface of the abrasive cloth can become undesirably coarse as a result of the conditioning operation. Then, it will become difficult to carry out a CMP operation in order to polish the films to be treated that are formed on the surface of a semiconductor substrate and make them satisfactorily planar.

Therefore, there is a strong demand for a CMP method and a semiconductor manufacturing method with which the abrasive cloth can be effectively subjected to a conditioning process by using a dresser that operate effectively relative to the abrasive cloth.

### BRIEF SUMMARY OF THE INVENTION

According to a first aspect of the present invention, there is provided a chemical mechanical polishing method comprising:

preparing a workpiece to be treated; and

chemically and mechanically polishing the workpiece to be treated by pressing the workpiece to be treated against a rotating disk carrying a piece of abrasive cloth bonded to a surface thereof at a first position on the disk, while dropping abrasive solution on the abrasive cloth, and, in parallel with the polishing, dressing the abrasive cloth by pressing a dresser carrying diamond grains sticked thereto against the abrasive cloth at a second position on the disk.

According to a second aspect of the invention, there is provided a semiconductor device manufacturing method comprising:

forming a film to be treated above a semiconductor substrate; and

chemically and mechanically polishing the film to be treated by pressing the film to be treated of the substrate against a rotating disk carrying a piece of abrasive cloth bonded to a surface thereof at a first position on the disk, while dropping abrasive solution on the abrasive cloth, and, in parallel with the polishing, dressing the abrasive cloth by pressing a dresser carrying diamond grains sticked thereto against the abrasive cloth at a second position on the disk.

### BRIEF DESCRIPTION OF THE SEVERAL VIEWS OF THE DRAWING

FIG. 1 is a schematic illustration of a CMP system that can be used with the first embodiment, showing the arrangement of system components;

FIG. 2 is a schematic perspective view of the CMP section of FIG. 1, illustrating its operation;

FIG. 3A is a schematic plan view of a dresser to be used with the first embodiment, illustrating its surface condition;

FIG. 3B is a schematic cross sectional view of the dresser of FIG. 3A;

FIG. 4A is a schematic plan view of a conventional dresser, illustrating its surface condition;

FIG. 4B is a schematic cross sectional view of the dresser of FIG. 4A;

FIG. 5 is a graph illustrating the distribution of diamond grains of the dresser of the first embodiment (A) in comparison with that of a known dresser (B);

FIGS. 6 and 7 are schematic cross sectional views of semiconductor devices used as objects of CMP for the second embodiment;

FIG. 8 is a graph illustrating the change with time of the extent of abrasion of a Cu film obtained by using the second embodiment;

FIG. 9 is a graph illustrating the planarizing performance of the second embodiment after a CMP process;

FIGS. 10A through 10C are schematic cross sectional views of a semiconductor device used as object of CMP for the third embodiment, illustrating different manufacturing steps; and

FIG. 11 is a schematic cross sectional view of a semiconductor device used as object of CMP for the third embodiment, illustrating a damascene wiring arrangement.

### DETAILED DESCRIPTION OF THE INVENTION

With a CMP method according to the embodiments of the invention, the abrasive cloth is subjected to conditioning during the CMP process being conducted on a wafer, using a dresser carrying diamond grains arranged substantially at regular intervals and having a uniform grain size, under a load lower than that of any conventional method. As a result, the problem of the reduction of the polishing rate that arises during the CMP process is suppressed to improve the effect of planarization and the dresser can be controlled quantitatively.

During a CMP process, debris of metal films and oxide films, abrasive grains contained in slurry and chemicals such as solvent may adhere to the abrasive cloth and the amount of such substances adhering to the abrasive cloth may increase as the polishing operation proceeds to by turn reduce the polishing rate. However, possible deposition of debris and abrasive grains on the abrasive cloth can be avoided to alleviate the problem of reduction of the polishing rate by conducting a conditioning operation during the process of polishing a silicon semiconductor substrate. A conditioning operation is an operation of pressing a disk (dresser), on which diamond grains with a grain size of 150 μm are electrodeposited at regular intervals of 0.7 μm, against a silicon semiconductor substrate that carries on the surface metal films, oxide films and so on and hence shows surface undulations.

Furthermore, the rate at which diamond grains bite the abrasive cloth can be reduced by selecting a load of 1.0 kgf/cm² to 20.0 kgf/cm² for pressing the disk carrying electrodeposited diamond grains against the semiconductor substrate. The polishing time will be prolonged if the load is smaller than 1.0 kgf/cm² whereas diamond grains will bite the abrasive cloth too deep if the load is greater than 20.0 kgf/cm². If diamond grains bite the abrasive cloth less, the surface of the abrasive cloth will become less coarse. Then, as a result, the adverse effect of the abrasive cloth touching recesses of the surface undulations of the semiconductor substrate, which carries metal films and oxide films formed thereon, can be reduced and the projections of the surface undulations can be abraded preferentially to satisfactorily planarize the surface.

Now, the present invention will be described in greater detail by referring to the accompanying drawings that illustrate preferred embodiments of the invention.

(1st Embodiment)

FIG. 1 is a schematic illustration of a CMP system that can be used with the first embodiment, showing the arrangement of system components. The components of the CMP system are arranged within a chamber 1 and include a CMP section 2 arranged for actual CMP operations, a cleaning section 3 for cleaning wafers that have been subjected to a CMP operation and a wafer loading/unloading section 4 for feeding workpieces to be treated that may typically be silicon semiconductor wafers. The wafer 10 fed from wafer cassette 5 in the loading/unloading section 4 is moved to the CMP section 2 by means of transfer robot 6a or 6b.

The CMP section 2 mainly comprises CMP units 22 and dressing units 23 arranged on respective turn tables 21.

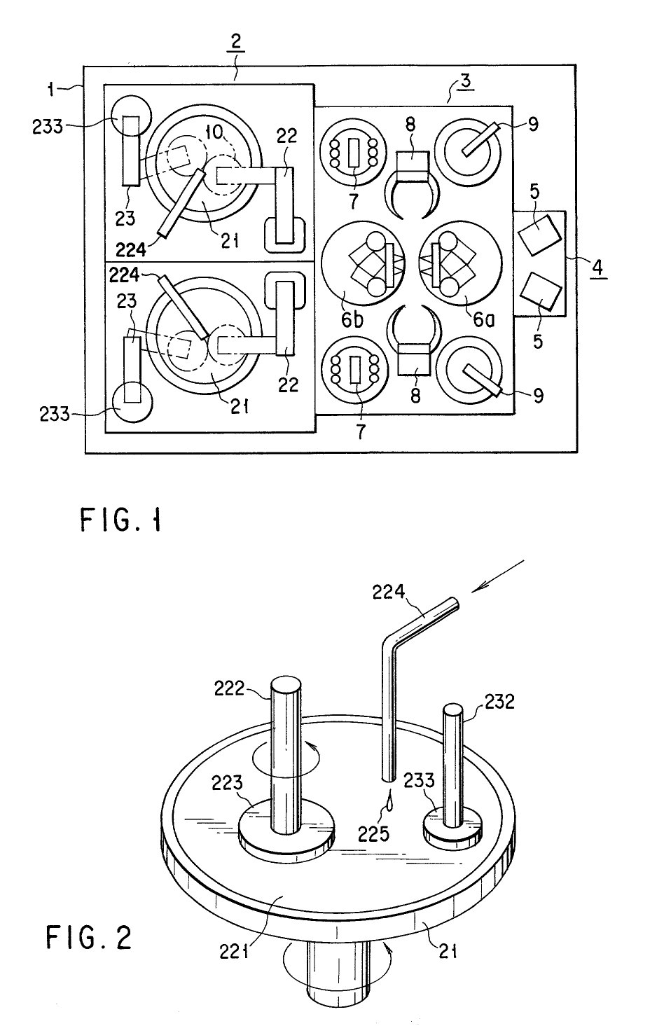

FIG. 2 is a schematic perspective view of a principal area of the CMP section containing a CMP unit 22 and a dressing unit 23. Referring to FIG. 2, abrasive cloth 221 is fitted onto the turn table 21 and is driven to rotate at a predetermined number of revolutions per unit time. As shown, a top ring 223 is fitted to a drive shaft 222 that is driven to rotate. A wafer is rigidly fitted to the top ring 223 and pressed against the abrasive cloth 221, while dropping slurry 225 fed from a slurry tank (not shown) by way of a slurry supply pipe 224 onto the polishing spot.

During the CMP process, a conditioning operation is conducted by bringing dresser 233 supported by another drive shaft 232 into contact with the abrasive cloth 221.

In the CMP process, the abrasive cloth is soaked with an abrasive agent referred to as slurry and containing abrasive grains and the wafer is chemically and mechanically polished on the rotating turn table to planarize the surface of the thin films arranged on the wafer. If the wafer is continuously polished in the CMP process, a problem of a clogged surface may arise to the abrasive cloth caused by debris of the abrasive agent. A surface treatment operation referred to as conditioning or dressing is conducted to recover the surface from clogging.

Each of the dressing units 23 in FIG. 1 is designed to perform a dressing operation on the abrasive cloth. The abrasive cloth that is typically made of polyurethane foam can be degraded during and after a CMP process using slurry due to the substances adhering thereto such as high molecular surfactant and polysaccharide as well as abrasive grains contained in the slurry.

The degraded abrasive cloth is a large factor that reduces the yield of manufacturing semiconductor devices in the CMP process of polishing wafers carrying semiconductor devices densely formed thereon to show micro-patterns. A dressing operation is conducted by means of a dressing unit to remove the foreign object clogging the surface of the abrasive cloth and scraping the surface of the latter. A dressing operation is normally conducted after chemically and mechanically polishing a wafer.

On the other hand, with this embodiment, a dressing operation is conducted on the abrasive cloth 221 arranged on the rotating turn table (disk) 21 during a CMP process. Additionally, as will be described hereinafter, the dresser 233 for dressing the abrasive cloth 221 is provided with diamond grains having substantially a same size and arranged substantially at regular intervals.

The wafer 10 that is treated by the CMP section 2 is then transferred to the cleaning section 3. The cleaning section 3 contains therein a pair of transfer robots 6a, 6b for transferring a wafer at a time, reversers 9 for reversing a wafer, double side roll cleaners 7 and pencil cleaners 8.

The wafer transferred from the CMP section 2 by the transfer robot 6b is washed and cleaned by the corresponding double side roll cleaner 7 and then transferred further to the pencil cleaner 8 by way of the transfer robot 6b, the reverser 9 and the transfer robot 6a. After drying, the wafer 10 is transferred to the loading/unloading section 4 by means of the transfer robot 6a and stored back in the wafer cassette 5. Thereafter, it is delivered to the outside and then to another station for the next manufacturing step.

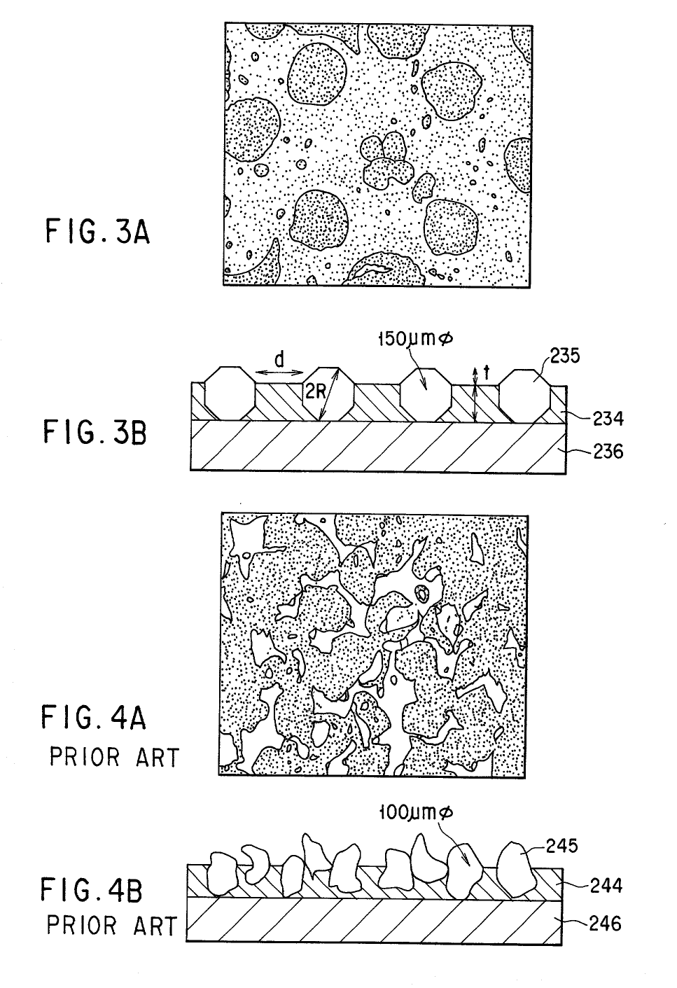

FIG. 3A is a schematic plan view of the dresser 233 to be used for the CMP process of the first embodiment, illustrating its surface condition. FIG. 3B is a schematic cross sectional view of the dresser 233.

Referring to FIGS. 3A and 3B, the substrate 236 of the dresser 233 is typically made of stainless steel such as SUS. A Ni plating layer 234 is typically formed on the substrate 236. Diamond grains 235 of about a same size, which is typically about 150 μm, are sticked to the Ni plating layer 234 substantially at regular intervals. The size of the diamond grains is preferably greater than 100 μm and smaller than 200 μm, more preferably not smaller than 120 μm and not greater than 180 μm.

The diamond grains 235 are buried into the Ni plating layer 234 by a predetermined depth so that they may hardly come off from the substrate 236. The diamond grains 235 will practically never come off from the dresser 233 if they are exposed from the Ni plating layer 234 by less than 50% of their grain size (2R), or a height (t) of the diamond grains 235 projecting from the Ni plating layer 234 satisfies the requirement of (t/2R)<0.5. Any two adjacent diamond grains 235 are preferably separated by a distance (d), not smaller than 0.1 mm and not greater than 1.0 mm. An inter grain distance (d) of 0.7 mm will be appropriate for the purpose of the embodiment (see FIG. 3B).

On the other hand, the substrate 246 of a known dresser as shown in FIGS. 4A and 4B is also typically made of stainless steel such as SUS. Again, a Ni plating layer 244 is typically formed on the substrate 246 and diamond grains 245 are buried in the Ni plating layer 234. While the average size of the diamond grains 245 is about 100 μm, they are not uniform and do not show a predetermined profile nor their arrangement is well controlled. Thus, the diamond grains 245 are apt to come off from the substrate 246.

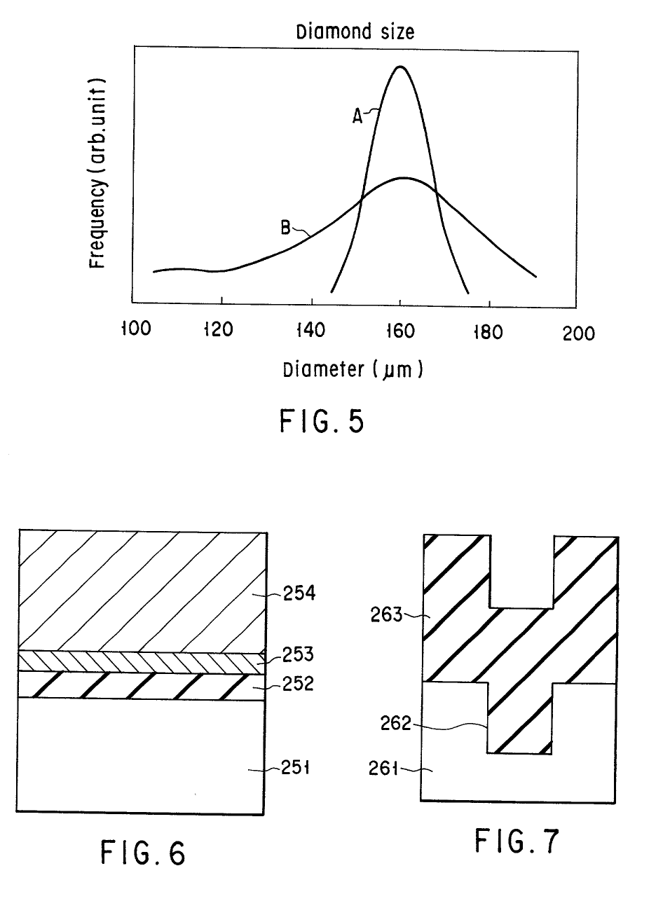

FIG. 5 illustrates the dispersion of the grain sizes of the diamond grains 235 of the dresser 233 of FIGS. 3A and 3B to be used with this embodiment in comparison with that of the diamond grains 245 of the known dresser of FIGS. 4A and 4B. In the graph of FIG. 5, the abscissa represents the grain size (μm) of diamond grain, while the ordinate represents the frequency of appearance. As seen from FIG. 5, the size distribution (A) of the diamond grains of the dresser to be used with this embodiment is found within a narrow range of about 40 μm because the grain size is limited to a predetermined value (centered at 160 μm in the case of the illustrated dresser), whereas the size distribution (B) of the diamond grains of the known dresser extends over a wider range.

As described above, the dresser to be used with this embodiment is so arranged as to efficiently condition the abrasive cloth and the abrasive cloth is conditioned during a CMP process of treating a wafer. As a result, any possible reduction of the polishing rate in a CMP process is effectively suppressed so that the effect of planarization is improved and it is possible to control the dresser quantitatively.

(2nd Embodiment)

Now, an embodiment of the present invention will be described in terms of application of the CMP method to the manufacture of semiconductor devices.

FIGS. 6 and 7 are schematic cross sectional views of a semiconductor substrate used as object of CMP for the second embodiment.

Referring firstly to FIG. 6, a specimen prepared by sequentially laying a 200 nm thick TEOS film 252 of silicon oxide, a 25 nm thick TaN film 253, a 2,000 nm thick Cu film 254 on a silicon substrate 251 is brought in. Beside, as shown in FIG. 7, a specimen prepared by forming a 700 nm deep groove 262 in a silicon substrate 261 and laying a 1,400 nm thick TEOS film 263 on the substrate 261 including the inside of the groove 262 is also brought in.

Each of the specimens of wafers is fitted to the top ring 223 of FIG. 2 and subjected to a CMP process, paralleling the dressing process with the dresser 233 of the first embodiment. The Cu film 254 of the specimen of FIG. 6 is polished. On the other hand, the TEOS film 263 on the silicon substrate 261 is abraded and removed and a buried insulating film to be used as element isolating region is formed there.

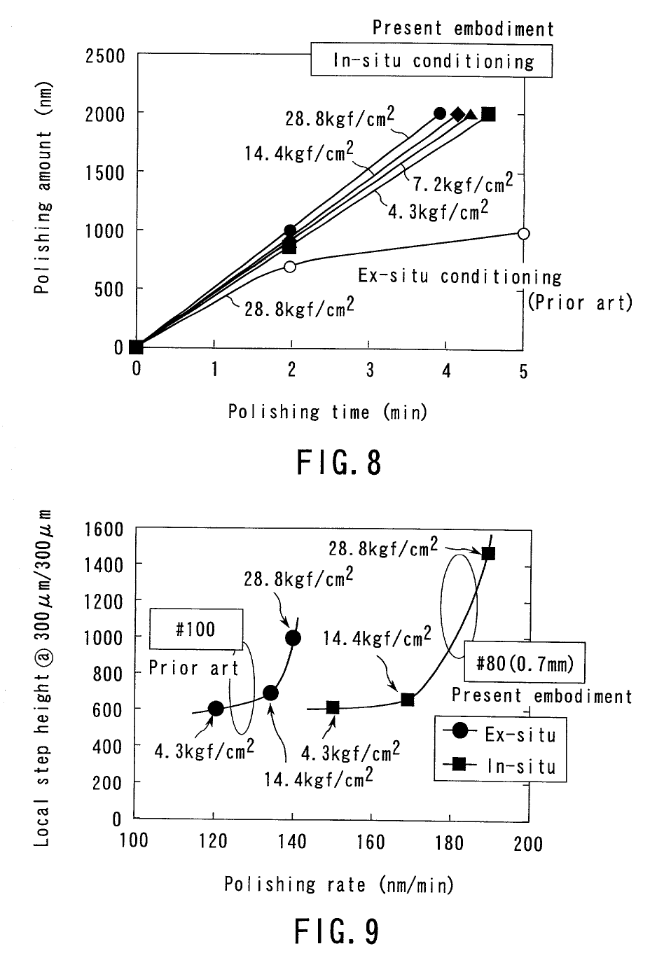

FIG. 8 illustrates the extent of abrasion of the Cu film 254 of the specimen of FIG. 6 in a CMP process. In the graph of FIG. 8, the ordinate represents the extent of abrasion (nm) (average abrasion amount per two minutes) and the abscissa represent the polishing time (nm). In the CMP process (in-situ conditioning) using this embodiment, four different loads of 4.3 kgf/cm², 7.2 kgf/cm², 14.4 kgf/cm² and 28.8 kgf/cm² are used for pressing the dresser. For the purpose of comparison, the data obtained as a result of a conditioning operation (ex-situ conditioning) using a known method with a load of 28.8 kgf/cm² for pressing the dresser is also shown.

As seen from FIG. 8, the extent of abrasion per unit time is extremely reduced with the known method as the polishing time increases. On the other hand, with this embodiment, the extent of abrasion per unit time does not practically fall at all if the polishing time is extended. The extent of abrasion per unit time increases when a large load is used.

Thus, while the polishing rate falls if the dresser is not subjected to conditioning during the polishing process, it is maintained to a desired level if the dresser is conditioned during the CMP process.

FIG. 9 is a graph illustrating the planarizing performance of the second embodiment after a CMP process conducted on the TEOS film 263 of the specimen of FIG. 7. In the graph of FIG. 9, the abscissa represents the polishing rate and the ordinate represents the local step height after the polishing process (@300 μm/300 μm). Note that @300 μm/300 μm indicates that the specimen had 300 μm wide projections and 300 μm wide grooves.

In FIG. 9, the curve indicated by #100 indicates the result obtained by using a known dresser provided with diamond grains of a size of about 100 μm and the curve indicated by #80 indicates the result obtained by using the dresser of this embodiment provided with diamond grains of a size of about 160 μm that are arranged at a pitch of 0.7 mm for conditioning.

From FIG. 9, it will be seen that the dresser of this embodiment performs best in terms of planarization when a load of 4.3 kgf/cm² is applied to it for dressing. The performance of the dresser is excellent in terms of planarization when the load is within a range between 1.0 kgf/cm² and 20.0 kgf/cm². Additionally, it will be seen that the embodiment can greatly increase the polishing rate if compared with the prior art, and therefore the use of the embodiment is very effective and efficient, even if the load for dressing is reduced to 1.0 kgf/cm² or more and 20.0 kgf/cm² or less.

Furthermore, while no numerical difference may appear if this embodiment is compared with the prior art in terms of local step height, the prior art dresser is always accompanied by the risk of falling diamond grains and hence the embodiment is by far superior in terms of quality.

Further, as shown in FIG. 9, the polishing method of this embodiment can obtain a sufficient polishing rate at a load for dressing lower than that of the prior art. Therefore, according to this embodiment, the load for dressing within a range from 1.0 kgf/cm² to 20.0 kgf/cm² can satisfy the requirements for the polishing rate and the planarization at the same time.

(3rd Embodiment)

Now, the third embodiment of CMP method will be described in terms of applying it to the damascene wiring of a semiconductor device.

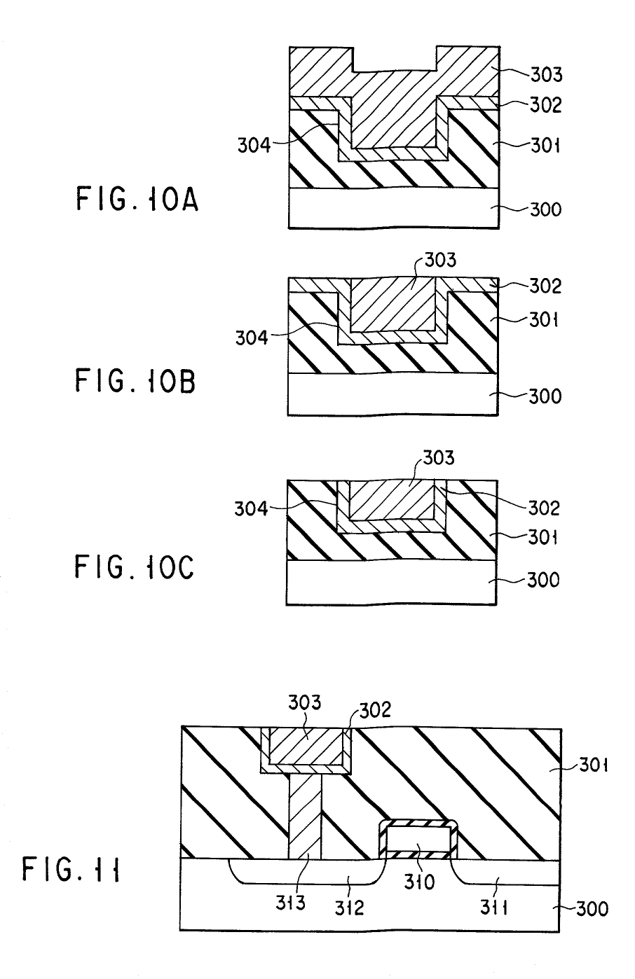

FIGS. 10A through 10C are schematic cross sectional views of a semiconductor device used as object of CMP for the third embodiment, illustrating different manufacturing steps. The A1 damascene wiring method realized by applying a CMP method aforementioned will be described below. For the purpose of simplification, some semiconductor elements are omitted from FIGS. 10A through 10C. However, assume that a transistor comprising a gate electrode 310 and source/drain 311, 312 is formed on a semiconductor substrate 300 and damascene wires 302/303 are formed on the surface of an interlayer insulating film 310 at a position located above the drain 312 with a contact hole 313 interposed between them.

Now, referring back to FIGS. 10A through 10C, an insulating film 301 that may typically be a silicon oxide film is formed on the semiconductor substrate 300 in which semiconductor elements (not shown) are formed. Then, a 400 nm thick wiring groove 304 is formed in the insulating film 301 by patterning. Subsequently, an about 30 nm thick Nb liner 302 is formed by deposition on the insulating film 301 and in the wiring groove 304. Thereafter, an about 600 nm thick Al film 303 is formed on the Nb liner 302 by deposition (FIG. 10A).

Then, The Al film 303 and the Nb liner 302 on the semiconductor substrate 300 are removed except the parts in the groove 304 by means of the first embodiment of CMP method, using the CMP system described above by referring to the first embodiment (see FIGS. 1 and 2). In this process, to begin with, a first step polishing operation is conducted to remove the A1 film 303 (FIG. 10B). Thereafter, a second polishing operation is conducted to remove the Nb liner 302 (FIG. 10C). This process is referred to as two-step polishing.

As a result of the CMP process, the Al film 303 that operates as wire and the Nb liner 302 that is a barrier metal layer are buried in the wiring groove 304. The remaining part of the Al film 303 and that of the Nb liner 302 are removed by the CMP process (see FIG. 10C).

Thus, with the third embodiment, a conditioning operation is conducted during the CMP process and hence a uniform polishing rate can be maintained. Therefore, buried wires can be formed accurately and reliably.

As described above in detail, according to the embodiments, a conditioning operation is conducted during a process of polishing a silicon semiconductor substrate having undulations on the surface as a result of forming metal films and oxide films on the surface. In the conditioning process, a dresser is pressed against the surface of the abrasive cloth. Diamond grains having a preferable size are sticked to the dresser. With this arrangement, debris produced as a result of polishing operation and abrasive grains can be prevented from depositing on the abrasive cloth as they are eliminated from the abrasive cloth and hence any possible fall of the polishing rate can be effectively suppressed. Additionally, the surface of the abrasive cloth can be prevented from becoming coarse by reducing a load for dressing to lessen the extent to which diamond grains are buried in the abrasive cloth. Then, as a result, the adverse effect of the abrasive cloth touching recesses of the surface undulations of the semiconductor substrate carrying metal films and oxide films can be reduced and the projections of the surface undulations can be abraded exclusively to satisfactorily planarize the surface.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A chemical mechanical polishing method comprising:
preparing a workpiece to be treated; and
chemically and mechanically polishing said workpiece to be treated by pressing said workpiece to be treated against a rotating disk carrying a piece of abrasive cloth bonded to a surface thereof at a first position on said disk, while dropping abrasive solution on said abrasive cloth, and, in parallel with said polishing, dressing said abrasive cloth by pressing a dresser carrying diamond grains sticked thereto against said abrasive cloth at a second position on said disk.

2. The method according to claim 1, wherein said dressing includes using said dresser on which said diamond grains are electrodeposited.

3. The method according to claim 1, wherein said dressing includes using said dresser in which said diamond grains are fixed to a substrate through a plated film.

4. The method according to claim 1, wherein said dressing includes pressing said dresser carrying said diamond grains against said abrasive cloth under pressure not lower than 1.0 kgf/cm² and not higher than 20.0 kgf/cm².

5. The method according to claim 1, wherein said dressing includes using said dresser carrying said diamond grains having grain sizes greater than 100 μm and smaller than 200 μm.

6. The method according to claim 1, wherein said dressing includes using said dresser carrying said diamond grains whose grain sizes are within a range of 40 μm.

7. The method according to claim 2, wherein, if a diameter of said diamond grains is 2R and a height of said diamond grains projecting from an electrodepositing surface of said dresser is t, said dressing includes using said dresser satisfying a requirement of (t/2R)<0.5.

8. The method according to claim 1, wherein said dressing includes using said dresser carrying said diamond grains sticked thereto in which any two adjacently located of said diamond grains are separated by an interval not less than 0.1 μm and not more than 1.0 μm.

9. A semiconductor device manufacturing method comprising:
forming a film to be treated above a semiconductor substrate; and
chemically and mechanically polishing said film to be treated by pressing said film to be treated of said substrate against a rotating disk carrying a piece of abrasive cloth bonded to a surface thereof at a first position on said disk, while dropping abrasive solution on said abrasive cloth, and, in parallel with said polishing, dressing said abrasive cloth by pressing a dresser carrying diamond grains sticked thereto against said abrasive cloth at a second position on said disk.

10. The method according to claim 9, wherein said forming a film to be treated includes forming at least one of a silicon oxide film and a metal film.

11. The method according to claim 9, wherein said dressing includes using said dresser on which said diamond grains are electrodeposited.

12. The method according to claim 9, wherein said dressing includes using said dresser in which said diamond grains are fixed to a substrate through a plated film.

13. The method according to claim 9, wherein said dressing includes pressing said dresser carrying said diamond grains against said abrasive cloth under pressure not lower than 1.0 kgf/cm² and not higher than 20.0 kgf/cm².

14. The method according to claim 9, wherein said dressing includes using said dresser carrying said diamond grains having grain sizes greater than 100 μm and smaller than 200 μm.

15. The method according to claim 9, wherein said dressing includes using said dresser carrying said diamond grains whose grain sizes are within a range of 40 μm.

16. The method according to claim 11, wherein,
if a diameter of said diamond grains is 2R and a height of said diamond grains projecting from an electrodepositing surface of said dresser is t,
said dressing includes using said dresser satisfying a requirement of (t/2R)<0.5.

17. The method according to claim 9, wherein said dressing includes using said dresser carrying said diamond grains sticked thereto in which any two adjacently located of said diamond grains are separated by an interval not less than 0.1 μm and not more than 1.0 μm.

18. A dresser to be used for CMP, said dresser comprising:
a substrate; and
a plurality of diamond grains stuck to said substrate by means of a plating film, in which grain sizes of said diamond grains are within a range of 40 μm, and a requirement of (t/2R)<0.5 is satisfied, 2R being a diameter of said diamond grains, t being a height of said diamond grains projecting from said plating film.

19. The dresser according to claim 18, wherein said diamond grains have grain sizes greater than 100 μm and smaller than 200 μm.

20. The dresser according to claim 18, wherein any two adjacently located of said diamond grains are separated by an interval not less than 0.1 μm and not more than 1.0 μm.
